(19) United States
(12) Patent Application Publication
(10) Pub. No.: US 2007/0201681 A1
(43) Pub. Date: Aug. 30, 2007

(54) MOBILE COMMUNICATION DEVICE AND METHOD FOR DISPLAYING CALL HISTORY THEREOF

(75) Inventors: CHING-YUAN CHEN, Shenzhen (CN); LEI PI, Shenzhen (CN); TSUNG-FU HUANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,426

(22) Filed: Aug. 4, 2006

(30) Foreign Application Priority Data
Feb. 11, 2006 (CN) 200610033622.X

(51) Int. Cl. H04M 1/00; H04M 3/00

(52) U.S. Cl. 379/355.02

(57) ABSTRACT

A mobile communication device (10) for processing calls of different types includes a call management module (30), a phone book module (40), a call history module (20), and a display module (50). The call management module processes the calls of different types, and generates call histories. Each of the call histories includes a phone number and a call type. The phone book module saves a plurality of phone entries, and each phone entry includes a name, a corresponding phone number, and a corresponding call type. The call history module is connected to the call management module and the phone book module, and saves the call histories. The display module is connected to the call history module, and displays the call histories.

### FIELD OF THE INVENTION

The invention relates to communication devices, and particularly to a mobile communication device and a method for displaying call history thereof.

### DESCRIPTION OF RELATED ART

Global system for mobile communications (GSM) and wireless fidelity (WIFI) dual mode phones have functions of voice over Internet protocol (VoIP) via wireless local area networks (WLAN). The GSM and WIFI dual mode phones can provide costless long-distance calls in areas of the WLAN, such as airports, hotels, and offices. Therefore, the GSM and WIFI dual mode phones have become more and more popular.

However, functions of the GSM and WIFI dual mode phones are insufficient and inconvenient. One of the problems encountered is that the dual mode phones cannot save and display GSM and WIFI call histories at the same time.

### SUMMARY OF THE INVENTION

An embodiment of the invention provides a mobile communication device for processing calls of different types. The mobile communication device includes a call management module, a phone book module, a call history module, and a display module. The call management module processes the calls of different types, and generates call histories. Each of the call histories includes a phone number and a call type. The phone book module saves a plurality of phone entries, and each phone entry includes a name, a corresponding phone number, and a corresponding call type. The call history module is connected to the call management module and the phone book module, and saves the call histories. The display module is connected to the call history module, and displays the call histories.

Another embodiment of the invention provides a method for displaying call history. The method for displaying call histories of different call types includes steps of receiving a call, and generating a call history including a phone number and a call type; receiving and saving the generated call history; searching a phone book module to determine whether there is a phone number in the phone book module matching with that of the generated call history; and displaying a name corresponding to the matched phone number in the phone book module and the call type of the generated call history.

Other advantages and novel features will become more apparent from the following detailed description when taken in conjunction with the accompanying drawings.

### BRIEF DESCRIPTION OF THE DRAWINGS

FIG. 1 is a schematic diagram of a mobile communication device of an embodiment of the invention.

FIG. 2 shows a schematic diagram of a call history module of FIG. 1.

FIG. 3 shows a schematic diagram of call history saving.

FIG. 4 shows a flowchart of a call history displaying method of another embodiment of the invention.

FIG. 5 shows a flowchart of a call history displaying method of a further embodiment of the invention.

### DETAILED DESCRIPTION OF THE INVENTION

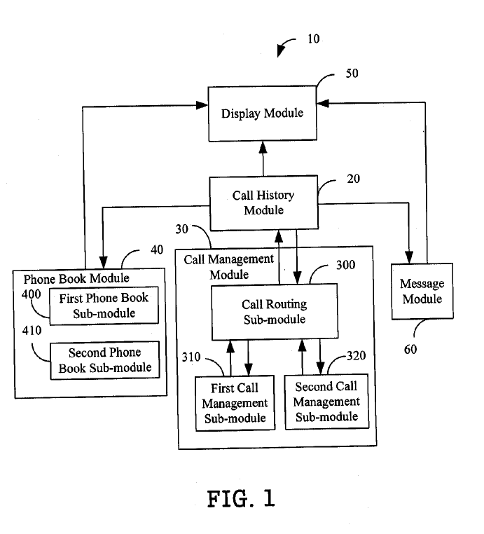

FIG. 1 is a schematic diagram of a mobile communication device 10 communicable with two communication networks including Global system for mobile communications (GSM) network and wireless fidelity (WIFI) network of an embodiment of the invention. In the embodiment, the mobile communication device 10 may be a dual mode phone, and includes a call history module 20, a call management module 30, a phone book module 40, a display module 50, and a message module 60. The call management module 30 is used for processing calls of different call types and generating call histories. In the embodiment, each of the call histories includes a phone number and a call type, and the call types include a first type and a second type. In the embodiment, the mobile communication device 10 may include a global system for mobile communications (GSM) and wireless fidelity (WIFI) dual mode phone, the first type may be GSM, and the second type may be WIFI. In the embodiment, the call histories include histories of incoming calls and outgoing calls.

The call management module 30 includes a call routing sub-module 300, a first call management sub-module 310, and a second call management sub-module 320. The first call management sub-module 310 is used for processing the first type calls. The second call management sub-module 320 is used for processing the second type calls. The call routing sub-module 300 is connected to the first call management sub-module 310 and the second call management sub-module 320 for determining call types and generating call histories.

When the mobile communication device 10 receives an incoming call, if the incoming call is the first type, the first call management sub-module 310 processes the incoming call, and sends the processed incoming call to the call routing sub-module 300; if the incoming call is the second type, the second call management sub-module 320 processes the incoming call, and sends the processed incoming call to the call routing sub-module 300. The call routing sub-module 300 determines call types of the received incoming call, and generates a call history. If the call routing sub-module 300 receives the processed incoming call from the first call management sub-module 310, the call routing sub-module 300 determines that the incoming call is the first type. If the call routing sub-module 300 receives the processed incoming call from the second call management sub-module 320, the call routing sub-module 300 determines that the incoming call is the second type.

When a call is outgoing from the mobile communication device 10, the call routing sub-module 300 determines whether the outgoing call is the first type or the second type, generates a corresponding call history, and sends a dial signal to the first call management sub-module 310 or the second call management sub-module 320. The first call management sub-module 310 or the second call management sub-module 320 sends out the dial signal.

The phone book module 40 is used for saving a plurality of phone entries, and each phone entry includes a name, a phone number, and a corresponding call type. In the embodiment, the phone book module 40 includes a first phone book sub-module 400 and a second phone sub-module 410. The first phone book sub-module 400 is used for saving phone entries of the first type, and the second phone book sub-module 410 is used for saving phone entries of the second type. The call history module 20 for saving call histories generated by the call management module 30 is connected to the call management module 30 and the phone book module 40. The display module 50 for displaying call histories is connected to the call history module 20. In alternative embodiments, the displaying module 50 for displaying phone entries saved in the phone book module 40 is connected to the phone book module 40.

The call history module 20 is further used for determining call types of received call histories and searching a corresponding sub-module of the phone book module 40 according to the call type to determine whether there is a phone number in the corresponding sub-module of the phone book module 40 matching with that of the received call history. If there is a matching phone number in the corresponding sub-module of the phone book module 40, the display module 50 displays a name corresponding to the phone number of the received call history and the call type thereof. If there is no matching phone number in the corresponding sub-module of the phone book module 40, the display module 50 displays the phone number of the received call history and the call type thereof. In the embodiment, the display module 50 indicates the first type and the second type respectively by a first icon and a second icon.

The message module 60 for receiving and sending messages is connected to the call history module 20 and the display module 50.

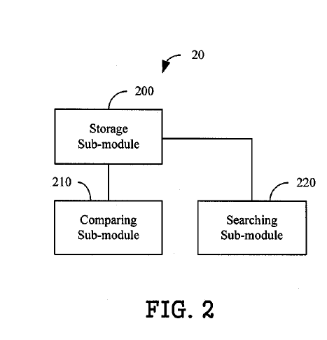

FIG. 2 is a schematic diagram of the call history module 20. In the embodiment, the call history module 20 includes a storage sub-module 200, a comparing sub-module 210, and a searching sub-module 220. The storage sub-module 200 saves call histories. In the embodiment, the storage sub-module 200 saves the call histories chronologically. The comparing sub-module 210 is connected to the storage sub-module 200 and the call routing sub-module 300, and receives call histories from the call routing sub-module 300 and determines whether there is a call history in the storage sub-module 200 matching with the received call histories. In the embodiment, the matching call histories have the same phone numbers. If there is a matching call history in the storage sub-module 200, the comparing sub-module 210 can delete old call histories in the storage sub-module 200, and save the updated received call histories from the call routing sub-module 300 in the storage sub-module 200. If there is no matching call history in the storage sub-module 200, the comparing sub-module 210 directly saves the received call histories from the call routing sub-module 300 in the storage sub-module 200. The searching sub-module 220 is connected to the storage sub-module 200 and the display module 50, and determines call types of the received call histories and searches a corresponding sub-module of the phone book module 40 according to the call type to determine whether there is a phone number in the corresponding sub-module of the phone book module 40 matching with those of the received call histories.

In an alternative embodiment, the call histories saved in the storage sub-module 200 include phone numbers, call count, call types, and call date. The call count is the number of matching call histories received or dialed. If the comparing sub-module 210 determines that there is a call history in the storage sub-module 200 matching with that received from the call routing sub-module 300, the comparing sub-module 210 deletes the matching call history in the storage sub-module 200, sets a call count of the call history received from the call routing sub-module 300 equal to a call count of the matching call history plus one, and saves the updated call history received from the call routing sub-module 300 in the storage sub-module 200. If the comparing sub-module 210 determines that there is no matching call history in the storage sub-module 200, the comparing sub-module 210 sets a call count of the call history received from the call routing sub-module 300 as one, and saves the updated call history in the storage sub-module 200.

If a user of the mobile communication device 10 makes a call via a call history in the storage sub-module 200 or a phone entry in the phone book module 40, the call routing sub-module 300 selects a corresponding call management sub-module to send a dial signal according to a call type of the selected call history or the selected phone entry, and generates a new call history. The mobile communication device 10 has four mode preset by the user: the first call type only, the second call type only, the first call type prefer, and the second call type prefer. When the user make a call via inputting a phone number not in the call histories and the phone entries, if the mobile communication device 10 is in the mode of the first call type only, the call routing sub-module 300 selects the first call management sub-module 310 to send a dial signal, and generates a call history of the first call type if successfully sending outing the dial signal; if the mobile communication device 10 is in the mode of the second call type only, the call routing sub-module 300 selects the second call management sub-module 320 to send a dial signal, and generates a call history of the second call type if successfully sending out the dial signal; if the mobile communication device 10 is in the mode of the first call type prefer, the call routing sub-module 300 selects the first call management sub-module 310 to send a dial signal, then selects the second call management sub-module 320 to send the dial signal if failing to send the dial signal by the first call management sub-module 310, and generates a call history of a corresponding call type; if the mobile communication device 10 is in the mode of the second call type prefer, the call routing sub-module 300 selects the second call management sub-module 320 to send a dial signal, then selects the first call management sub-module 310 to send the dial signal if failing to send the dial signal by the second call management sub-module 320, and generates a call history of a corresponding call type.

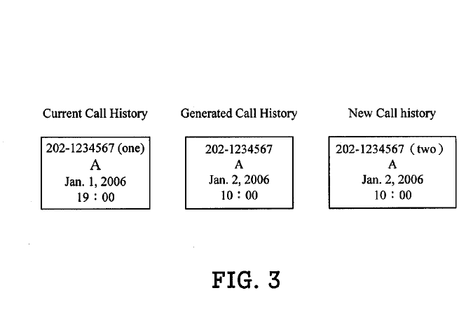

FIG. 3 is a schematic diagram of call history saving. A phone number of a current call history in the storage sub-module 200 is 202-1234567, a call type thereof is the first type denoted by “A”, a call date thereof is 19:00 of Jan. 1, 2006, and a call count thereof is one (the first time). The call routing sub-module 300 generates a call history, whose phone number is 202-1234567 the same as the phone number of the current call history, the call type thereof is the first type, and the call date is 10:00 of Jan. 2, 2006. The comparing sub-module 210 determines the phone number of the current call history matching with the phone number of the generated call history, deletes the current call history, sets a call count of the generated call history as two (the second time), and saves the generated call history in the storage sub-module 200. As a result, a phone number of a new call history in the storage sub-module 200 is 202-1234567, a call type thereof is the first type denoted by “A”, a call date thereof is 10:00 of Jan. 2, 2006, and a call count thereof is two.

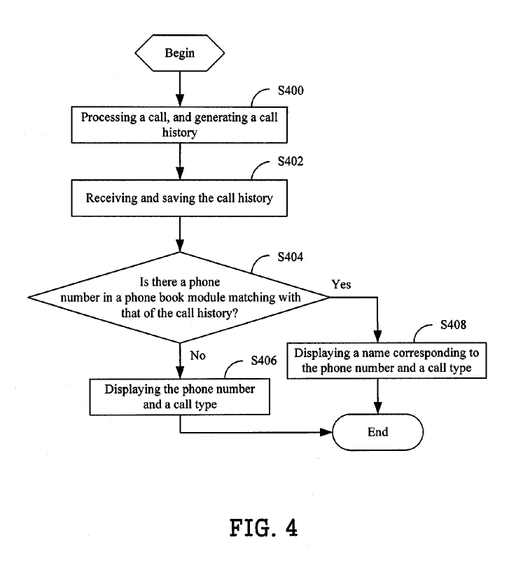

FIG. 4 is a flowchart of a call history displaying method of an embodiment of the invention. In step S400, the call routing sub-module 300 processes a call, and generates a call history. In the exemplary embodiment, the call includes incoming calls and outgoing calls. If the call is an incoming call, the call routing sub-module 300 determines the a type of the call according to a call management sub-module that sends the call to the call routing sub-module 300, and generates the call history of a type corresponding to the call management sub-module. If the call is an outgoing call via the call history or the phone entries, the call routing sub-module 300 determines the call type of the call, sends out the call according to the call type, and generates a call history of the same call type. If the call is an outgoing call including a phone number not in the call history and the phone entries, the call routing sub-module 300 processes the call according to the mode of the mobile communication device 10, and generates a corresponding call history. In step S402, the call history module 20 receives and saves the call history.

In step S404, the call history module 20 searches the phone book module 40 to determine whether there is a phone number in the phone book module 40 matching with that of the call history. In the embodiment, the searching sub-module 220 first determines the call type of the call history, and then searches the phone book module 40 according to the call type to determine whether there is a phone number in the phone book module 40 matching with that of the call history.

If there is no matching phone number in the phone book module 40, in step S406, the display module 50 directly displays the phone number and the call type of the call history. If there is a matching phone number in the phone book module 40, in step S408, the display module 50 displays a name in the phone book module 40 corresponding to the phone number and the call type. In the embodiment, the display module 50 also displays the icon corresponding to the call type.

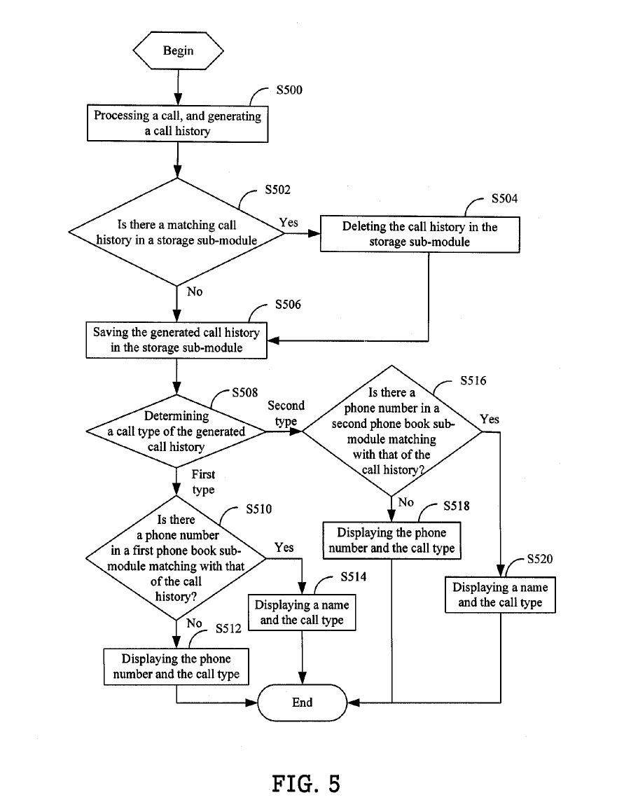

FIG. 5 is a detailed flowchart of the call history displaying method. In step S500, the call routing sub-module 300 processes a call, and generates a call history. In the exemplary embodiment, the call includes incoming calls and outgoing calls. The call history includes a phone number and a call type. In step S502, the comparing sub-module 210 receives the call history, and determines whether there is an existing call history in the storage sub-module 200 matching with the generated call history. In the embodiment, the matching call histories have the same phone numbers. If there is no matching call history, in step S506, the comparing sub-module 210 saves the generated call history in the storage sub-module 200. If there is a matching call history, in step S504, the comparing sub-module 210 deletes the matching call history in the storage sub-module 200. Then, the procedure goes to step S506.

In alternative embodiments, the call history further includes a call count, and in step S506, the comparing sub-module 210 first sets the call count of the call history equal to a call count of the matching call history in the storage sub-module 200 plus one, and then saves the updated call history in the storage sub-module 200.

In step S508, the searching sub-module 220 determines the call type of the call history, that is determines whether the call history is of the first type or the second type.

If the call type of the call history is the first type, in step S510, the searching sub-module 220 searches the first phone book sub-module 400 to determine whether there is a phone number in the first phone book sub-module 400 matching with that of the call history. If there is no matching phone number in the first phone book sub-module 400, in step S512, the display module 50 directly displays the phone number and the call type of the call history. If a matching phone number in the first phone book sub-module 400 is found, in step S514, the display module 50 displays a name in the first phone book sub-module 400 corresponding to the phone number and the call type.

If the call type of the call history is the second type, in step S516, the searching sub-module 220 searches the second phone book sub-module 410 to determine whether there is a phone number in the second phone book sub-module 410 matching with that of the call history. If there is no matching phone number in the second phone book sub-module 410, in step S518, the display module 50 directly displays the phone number and the call type of the call history. If there is a matching phone number in the second phone book sub-module 410, in step S520, the display module 50 displays a name in the second phone book sub-module 410 corresponding to the phone number and the call type.

The mobile communication device 10 can save phone numbers of the different types, for example, GSM and WiFi types, and display call types of the call history.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A mobile communication device, for processing calls of different types, comprising:
a call management module, for processing the calls of different types and generating call histories, wherein each of the call histories comprises a phone number and a call type;
a phone book module, for saving a plurality of phone entries, wherein each phone entry comprises a name, a corresponding phone number, and a corresponding call type;
a call history module, connected to the call management module and the phone book module, for saving the call histories; and
a display module, connected to the call history module, for displaying the call histories.

2. The mobile communication device of claim 1, wherein the call history module is further used for determining whether there is a phone number in the phone book module matching with that of a received call history.

3. The mobile communication device of claim 2, wherein the display module is further used for displaying a name corresponding to the phone number and the call type of the received call history.

4. The mobile communication device of claim 2, wherein the call history module comprises:
a storage sub-module, for saving the call histories;
a comparing sub-module, connected to the call management module, for receiving the received call history from the call management module, determining whether there is a call history in the storage sub-module matching with the received call history, deleting the matched call history in the storage sub-module, saving the received call history in the storage sub-module if a matching call history is found, and directly saving the received call history in the storage sub-module if no matching call history is found; and
a searching sub-module, connected to the storage sub-module, for searching the phone book module to determine whether there is a phone number in the phone book module matching with that of the received call history.

5. The mobile communication device of claim 1, wherein the call type includes a first type and a second type.

6. The mobile communication device of claim 5, wherein the first type is a global system for mobile communications mode, and the second type is a wireless fidelity (WIFI) mode.

7. The mobile communication device of claim 5, wherein the phone book module comprises:
a first phone book sub-module, for saving phone entries of the first type; and
a second phone book sub-module, for saving phone entries of the second type.

8. The mobile communication device of claim 5, wherein the call management module comprises:
a first call management sub-module, for processing calls of the first type;
a second call management sub-module, for processing calls of the second type; and
a call routing sub-module, connected to the first call management sub-module and the second call management sub-module, for determining the call type of calls and generating call histories.

9. The mobile communication device of claim 8, wherein the call routing sub-module is further used for sending a dial signal to a corresponding call management sub-module according to the call type of a selected call history.

10. The mobile communication device of claim 1, wherein the call history further comprises a call date and a call count, and the call count is the number of matching call histories received or dialed.

11. A method for displaying call histories of a mobile communication device with different call types, comprising:
receiving a call, and generating a call history, wherein the call history comprises a phone number and a call type;
receiving and saving the generated call history;
searching a phone book module to determine whether there is a phone number in the phone book module matching with that of the generated call history; and
displaying a name corresponding to the matching phone number in the phone book module and the call type of the generated call history.

12. The call history displaying method of claim 11, wherein the step of receiving and saving the generated call history comprises steps of:
determining whether there is a call history in a call history module matching with the generated call history; and
saving the generated call history in the call history module if there is no matching call history.

13. The call history displaying method of claim 12, wherein the step of receiving and saving the generated call history further comprises steps of:
deleting the matching call history in the call history module, and saving the generated call history in the call history module.

14. The call history displaying method of claim 13, wherein the call history further comprises a call count.

15. The call history displaying method of claim 12, wherein the if there is a call history in a call history module matching with the call history, setting the call count of the call history equal to a call count of the matching call history in the call history module plus one.

16. The call history displaying method of claim 11, further comprising steps of: displaying the phone number and the call type of the generated call history if there is no matching phone number in the phone book module.

17. The call history displaying method of claim 11, wherein the call type comprises a first type and a second type.

18. The call history displaying method of claim 17, wherein the step of searching a phone book module to determine whether there is a phone number in the phone book module matching with that of the generated call history comprises steps of:
determining a call type of the call history; and
searching the phone book module according to the call type to determine whether there is a phone number in the phone book module matching with that of the generated call history.

19. The call history displaying method of claim 18, wherein the step of searching the phone book module according to the call type to determine whether there is a phone number in the phone book module matching with that of the generated call history comprises steps of:
searching a first phone book sub-module of the phone book module to determine whether there is a phone number in the first phone book sub-module matching with that of the generated call history if the call type is the first type; and
searching a second phone book sub-module of the phone book module to determine whether there is a phone number in the second phone book sub-module matching with that of the generated call history if the call type is the second type.

20. A method for managing call histories of a mobile communication device communicable with at least two different communication networks, comprising the steps of:
processing a call through a mobile communication device communicable with at least two different communication networks;
generating a call history corresponding to said processed call to include a call type of said processed call indicating a current communication network out of said at least two different communication network by which said call is processed; and
managing said call history in said mobile communication device based on advance verification of said call type from said call history.
